(19) United States
(12) Patent Application Publication
(10) Pub. No.: US 2009/0319644 A1
(43) Pub. Date: Dec. 24, 2009

(54) METHODS AND APPARATUS FOR AUTOMATICALLY CONFIGURING COMPUTING DEVICES FOR WIRELESS NETWORK CONNECTIONS

(75) Inventors: James Fagioli, Holtsville, NY (US); Prashanth Kadur, Coram, NY (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 12/142,647

(22) Filed: Jun. 19, 2008

(51) Int. Cl. G06F 15/177

(52) U.S. Cl. 709/221

(57) ABSTRACT

Methods and apparatus are provided for configuring a first computing device and a second computing device for operation over a wireless network. A method comprises coupling the first computing device and the second computing device to establish a data communication link, and exchanging configuration information using the data communication link. The configuration information may be utilized for communication over the wireless network between the first computing device and the second computing device. The method may further comprise establishing a communication session over the wireless network between the first computing device and the second computing device using the configuration information.

### TECHNICAL FIELD

Embodiments of the subject matter described herein relate generally to mobile computing devices, and more particularly, embodiments of the subject matter relate to methods for automatically configuring mobile computing devices for communication over a wireless network.

### BACKGROUND

Mobile computing devices, such as portable scanning devices (e.g., barcode scanners, credit card readers) and RFID readers, are available from manufacturers such as Symbol Technologies, Inc. These mobile computing devices are usually designed with wireless data communication features that allow them to communicate with a wireless network, e.g., a wireless local area network (WLAN). WLANs rely on WLAN infrastructure components that establish data communication links with mobile client devices. A mobile client device communicates, via a wireless data communication channel, with an access point or access port device, which in turn communicates with other network components via traditional wired interfaces. This generally involves the use of wireless access devices that communicate with the mobile client devices using one or more RF channels (e.g., in accordance with one or more of the IEEE 802.11 standards).

A mobile computing device may be configured with generic configuration data, software applications, security settings, and possibly other data necessary for compatible operation with the intended wireless network infrastructure and wireless network applications. Some software applications, such as the DataWedge application available from Symbol Technologies, Inc., allow a mobile computing device to transmit scanned data and/or import data to a host computing device by communicating with the host computing device over a wireless network. In order to communicate these applications require provisioning configuration information (e.g., IP address, port identifier) corresponding to the destination device (e.g., host computing device).

However, traditional techniques for configuring or provisioning a mobile computing device for communication with another device rely on somewhat cumbersome, time consuming, or user-involved procedures. For example, one conventional technique for provisioning a mobile computing device involves manually updating or providing configuration information for the host computing device to the mobile computing device, and updating or providing configuration information for the mobile computing device to the host computing device. Thereafter, the mobile computing device and the host computing device can communicate over the wireless network and transmit or download additional data. While such techniques may be effective for relatively small scale deployments, they can become very time consuming and inefficient for large scale applications having a large number of mobile computing devices. Furthermore, the process of provisioning or configuring the computing devices must be repeated each time a user desires to use the mobile computing device with a different host computing device. Moreover, existing techniques may be susceptible to human data entry errors.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an exemplary wireless network in accordance with one embodiment;

FIG. 2 is a schematic representation of an exemplary computing device suitable for use in the wireless network shown in FIG. 1 for one embodiment;

FIG. 3 is a flow diagram of a configuration process in accordance with one embodiment;

FIG. 4 is a schematic diagram of a wireless network showing an exemplary data link communication session between a mobile computing device and a host computing device in accordance with one embodiment; and

FIG. 5 is a schematic diagram of a wireless network showing an exemplary communication session between a mobile computing device and a host computing device in accordance with one embodiment.

### DETAILED DESCRIPTION

The following detailed description is merely illustrative in nature and is not intended to limit the embodiments of the subject matter or the application and uses of such embodiments. Furthermore, there is no intention to be bound by any expressed or implied theory presented in the preceding technical field, background, brief summary or the following detailed description.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of network architectures, data transmission protocols, and mobile computing device configurations, and that the system described herein is merely one suitable example.

For the sake of brevity, conventional techniques related to wireless signal processing, wireless data transmission, WLANs, signaling, network control, wireless switches, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

Those of skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application.

Technologies and/or concepts described herein relate to automatically configuring two computing devices for communication over a wireless network, with limited user involvement. In an exemplary embodiment, the two computing devices are briefly coupled while in close proximity in order to exchange configuration information. The computing devices are then capable of using the received configuration information to create a communication session and transmit data as desired.

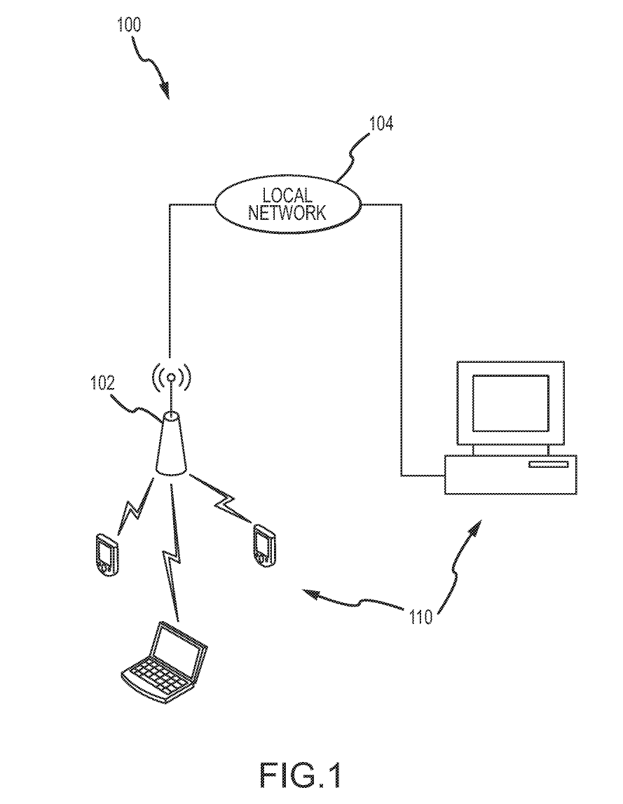

Referring now to FIG. 1, in an exemplary embodiment, a wireless network 100 includes, without limitation, at least one access device 102 and a local network 104. In an exemplary embodiment, the wireless network 100 is configured to support communications between and/or among computing devices 110. The computing devices 110 may be configured to support communications with access devices 102 (e.g., via wireless) or the local network 104 (e.g., Ethernet) as will be understood. It should be understood that FIG. 1 is a simplified representation of a wireless network 100 for purposes of explanation and ease of description. A practical embodiment may have any number of access devices 102, and may include additional devices to support the functionality of the wireless network 100, such as Ethernet switches, wireless switches, and the like. The topology and configuration of the wireless network 100 can vary to suit the needs of the particular application and FIG. 1 is not intended to limit the application or scope of the subject matter in any way.

In an exemplary embodiment, the wireless network 100 is configured as a wireless local area network (WLAN). In alternative embodiments, the wireless network 100 may be configured as a wireless personal area network (WPAN), a wireless wide area network (WWAN), or any other suitable network configuration. The wireless network 100 may be configured to utilize a data communication protocol in accordance with IEEE 802. 11, conventional Internet Protocol techniques, TCP/IP, hypertext transfer protocol (HTTP), SOAP, or another comparable protocol.

For the illustrated embodiment, access device 102 is realized as a wireless access point, which is a “thick” device having embedded network intelligence and management functions. In alternate embodiments, access device 102 may be a wireless access port, which is a “thin” device that relies on the network intelligence and management functions provided by a wireless switch (not shown in FIG. 1). A variety of wireless access ports and wireless access points are available from Symbol Technologies, Inc. In an exemplary embodiment, the access device 102 is coupled to the local network 104, which in turn may be coupled to one or more additional computer networks, as will be understood. Depending on the embodiment, the access device 102 may be coupled to the local network 104 via one or more additional access points, wireless switches, Ethernet switches, and/or various combinations thereof. In an exemplary embodiment, the access device 102 is configured to transmit and/or receive data to and/or from computing devices 110 over wireless data communication links. Once that data is captured by the access device 102, the data may be encapsulated (e.g., into a packet format compliant with a suitable data communication protocol) for communication to another access point, computing device 110, and/or the local network 104, as will be understood. The local network 104 is suitably configured to enable communication between or among access devices and other computer networks.

In an exemplary embodiment, the computing devices 110 may include various combinations of computers, workstations, servers, laptop computers, handheld computers, personal digital assistants (PDAs), cellular phones, barcode scanners, mobile computers, RFID readers, and the like. The computing devices 110 may be connected to the network 100 via a wireless data communication link (e.g., wirelessly) and/or a wired communication link (e.g., Ethernet). Accordingly, a given computing device 110 in a wireless network 100 may be primarily mobile (e.g., primarily communicates wirelessly) or primarily stationary (e.g., primarily communicates over wired communication links) as will be understood.

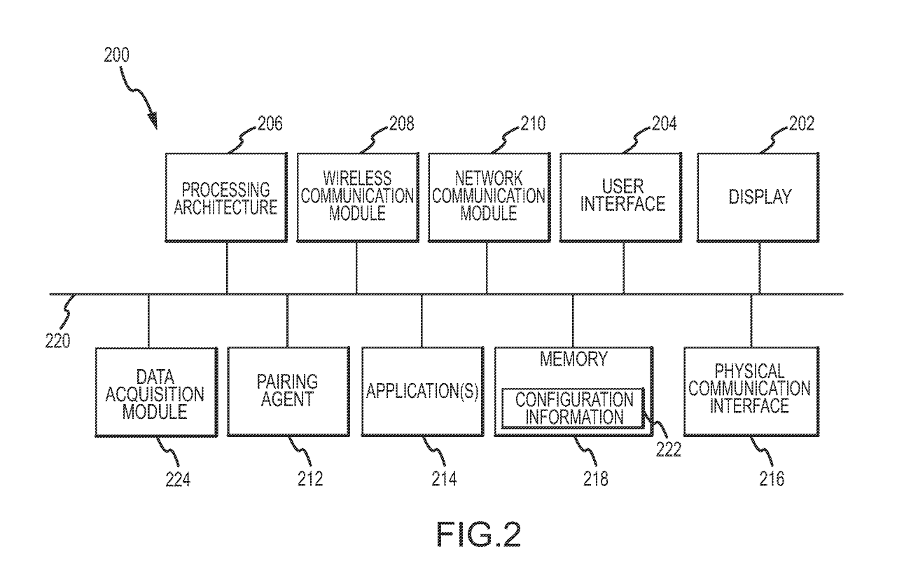

FIG. 2 is a schematic representation of an embodiment of computing device 200 suitable for use in a network, such as wireless network 100 shown in FIG. 1. A computing device 200 may include, without limitation: a display 202, a user interface 204; a processing architecture 206; a wireless communication module 208, a network communication module 210; a pairing agent 212; one or more applications 214; a physical communication interface 216; and a suitable amount of memory 218. The elements of computing device 200 may be interconnected together using a bus 220 or another suitable interconnection arrangement that facilitates communication between the various elements of computing device 200. In some embodiments, the computing device 200 may also include a data acquisition module 224, to support additional functionality as described below. It should be understood that FIG. 2 depicts computing device 200 in an oversimplified manner, and a practical embodiment may include fewer components or many additional features and components, and suitably configured processing logic related to common features and functions that are not described in detail herein.

In an exemplary embodiment, the display 202 and the user interface 204 function as input/output elements for a user and/or operator of computing device 200. The display 202 and user interface 204 may be coupled to one or more electronics modules (not shown) as necessary to support input/output functions in a conventional manner. In addition, the display 202 and user interface 204 may be utilized to obtain instructions from the user and/or to convey information to the user, as will be understood. In various embodiments, the user interface 204 may be realized as a keypad, a touchpad, a keyboard, a mouse, a touchscreen, or another suitable input device capable of receiving input from a user.

In an exemplary embodiment, the processing architecture 206 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. In practice, processing architecture 206 includes processing logic that may be configured to carry out the functions, techniques, and processing tasks associated with the operation of computing device 200, as described in greater detail below. Furthermore, the steps of a method or algorithm described in connection with the embodiments disclosed herein may be embodied directly in hardware, in firmware, in a software module executed by processing architecture 206, or in any practical combination thereof.

In an exemplary embodiment, the wireless communication module 208 is suitably configured to support wireless data communication for the computing device 200. For example, referring to FIG. 1, wireless communication module 208 may facilitate wireless communication with the wireless network 100 and/or local network 104 via the access device 102. Wireless communication module 208 may also be configured to support wireless communication with other devices within a wireless network, as described in greater detail below. For the embodiments described herein, wireless communication module 208 is configured to support bidirectional communication between the computing device 200 and the wireless network using wireless communication links. Wireless communication module 208 may include or be realized as a radio module that supports one or more wireless data communication protocols and one or more wireless data transmission schemes. In an embodiment of computing device 200, wireless communication module 208 may include or be realized as hardware, software, and/or firmware, such as an RF front end, a suitably configured radio module (which may be a stand alone module or integrated with other or all functions of computing device 200), a wireless transmitter, a wireless receiver, a wireless transceiver, an infrared sensor, an electromagnetic transducer, or the like. In practice, computing device 200 may include one or more antennas coupled to wireless communication module 208 and appropriately configured in accordance with the particular design of wireless communication module 208.

Wireless communication module 208 may support one or more wireless data communication protocols that are also supported by the wireless network. Any number of suitable wireless data communication protocols, techniques, or methodologies may be supported by wireless communication module 208, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. In an exemplary embodiment, wireless communication module 208 is preferably compliant with at least the IEEE 802.11 specification.

In an exemplary embodiment, network communication module 210 is suitably configured to support data communication via a wired, cabled, or other tangible data communication link. For the embodiments described herein, network communication module 210 is configured to support bidirectional communication between computing device 200 and the wireless network (e.g., via local network 104) using a tangible data communication link. It should be appreciated that the computing device 200 may or may not include both the wireless communication module 208 and the network communication module 210, and that in various embodiments, a computing device 200 may include only one of the communication modules 208, 210.

In an exemplary embodiment, the pairing agent 212, which may be partially or completely realized in processing architecture 206, represents a software application, module, firmware, processing logic, and/or a feature of computing device 200 that enables the configuration techniques as described below. In an exemplary embodiment, the pairing agent 212 is configured to initiate a data transfer session and facilitate the exchange of configuration information in response to coupling another computing device to computing device 200. During the data transfer session, the pairing agent 212 may receive configuration information relating to the other computing device, and may transmit configuration information relating to computing device 200, as described below.

In an exemplary embodiment, the application 214 comprises one or more software applications, computer programs, or agents for computing device 200, which may be partially or completely realized in processing architecture 206. Application(s) 214 may be device-specific and/or network-specific, and may be utilized to provide a desired functionality and feature set to computing device 200. One or more applications 214 may also enable computing device 200 to become compatible with the particular wireless network, and/or communicate data to another computing device (e.g., transfer and/or receive data to/from) as described herein.

In an exemplary embodiment, physical communication interface 216 may include interface logic and an interface port, which may be realized as a cable connector, receptacle, jack, or plug. The interface logic may be implemented in processing architecture 206. In an exemplary embodiment of computing device 200, physical communication interface 216 is a universal serial bus interface (USB), the interface logic is compatible with USB specifications and requirements, and the interface port is a USB port or connector. Of course, alternate embodiments may utilize different interface configurations (for example, IEEE 1394) and, therefore, different interface connectors, ports, couplers, or the like. For transmission of data over a cable, a wired connection, a direct connection, or other tangible link, physical communication interface 216 may support one or more wired/cabled data communication protocols that are also supported by the network infrastructure. Any number of suitable data communication protocols, techniques, or methodologies may be supported by physical communication interface 216, including, without limitation: Ethernet; home network communication protocols; USB; IEEE 1394 (Firewire); hospital network communication protocols; and proprietary data communication protocols. As mentioned above, physical communication interface 216 is preferably compliant with at least the USB specification.

In an exemplary embodiment, memory 218 may be realized as RAM memory, flash memory, ROM memory, EPROM memory, EEPROM memory, registers, a hard disk, a removable disk, a CD-ROM, or any other form of storage medium known in the art. In this regard, memory 218 can be coupled to processing architecture 206 such that processing architecture 206 can read information from, and write information to, memory 218. In the alternative, memory 218 may be integral to processing architecture 206. As an example, processing architecture 206 and memory 218 may reside in an ASIC. In accordance with one embodiment, one or more software modules may reside in memory 218 (e.g., pairing agent 212 or application(s) 214). In an exemplary embodiment, memory 218 is utilized to store configuration information 222 associated with the computing device 200 for establishing a communication session with another device over a network, as described below. Depending on the embodiment, the configuration information 222 may include, for example, an IP Address and a port number, and/or other additional information or settings for enabling communication, as described below.

In accordance with one or more embodiments, the computing device 200 may include a data acquisition module 224, which may be configured to obtain data and/or information from external sources. For example, the data acquisition module 224 may include an RFID reader, a barcode scanner, magnetic stripe reader (MSR), or another suitable data acquisition means capable of obtaining data and/or information from an external source (e.g., RFID tag, barcode, credit card). The data acquisition module 224 may include additional components, such as antennas, transponders, and the like, to support the functionality of the data acquisition module 224, as will be appreciated in the art.

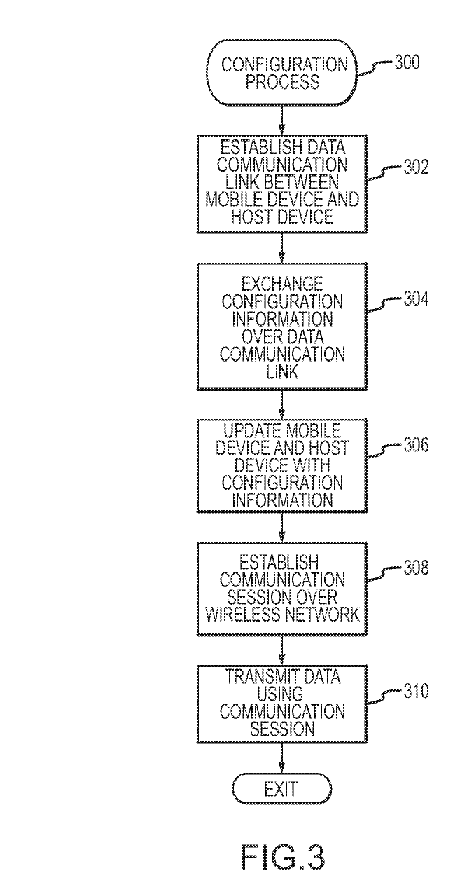

Referring now to FIG. 3, in an exemplary embodiment, a computing device 110, 200 may be configured to perform a configuration process 300 and additional tasks, functions, and/or operations as described below. The various tasks may be performed by software, hardware, firmware, or any combination thereof. For illustrative purposes, the following description may refer to elements mentioned above in connection with FIG. 1 and FIG. 2. In practice, the tasks, functions, and operations may be performed by different elements of the described system, such as the computing device 110, 200, the processing architecture 206, the pairing agent 212, a specific application 214, or the physical communication interface 216. It should be appreciated any number of additional or alternative tasks may be included, and may be incorporated into a more comprehensive procedure or process having additional functionality not described in detail herein.

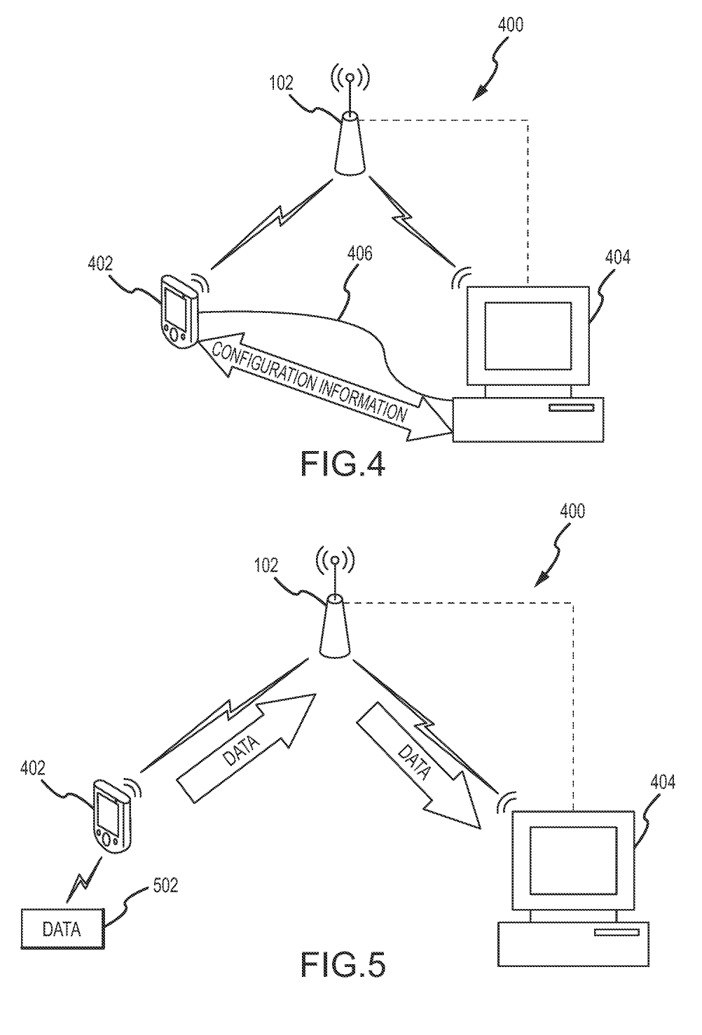

Referring now to FIG. 3 and FIG. 4, and with continued reference to FIG. 1 and FIG. 2, a configuration process 300 may initialize when a user couples a first computing device to a second computing device to establish a data communication link (task 302). For example, in an exemplary embodiment shown in FIG. 4, a user may couple a mobile computing device 402 (e.g., mobile/cellular phone, handheld computer, RFID reader, barcode scanner, credit card reader) to a host computing device 404 (e.g., workstation, cash register, personal computer, server) to establish the data communication link. In an exemplary embodiment, the host computing device 404 may connect to the wireless network 400 via a wireless communication link and/or a wired communication link, as will be understood. It should be appreciated, however, that the distinction between mobile and host is for purpose of explanation and does not contemplate any structural or functional limitations which may be implied. The subject matter described herein may be used with numerous possible device combinations, and should not be construed as limited to the depicted embodiments. For example, either and/or both computing devices 402, 404 may be realized and/or configured as computing device 200 shown and described in the context of FIG. 2, and either and/or both computing devices 402, 404 may be mobile or primarily stationary. In an exemplary embodiment, the two computing devices 402, 404 may each include a respective pairing agent (e.g., pairing agent 212) configured to communicate with the pairing agent on the other computing device, as described herein.

In the embodiment shown in FIG. 4, a physical data communication interface 406 (e.g., USB, IEEE 1394) is used to couple the mobile computing device 402 and the host computing device 404. In alternative embodiments, the data communication link may be established using Bluetooth, infrared, RFID, or another data communication interface that allows two computing devices to directly communicate. In an exemplary embodiment, the computing devices 402, 404 are adapted, configured, or otherwise capable of detecting a coupled computing device and establishing a data communication link between the coupled computing devices, for example, by using a synchronization program. Synchronization programs and other specific methods and/or means for detecting another device and establishing a data communication link are known in the art, and accordingly will not be described herein.

Referring again to FIG. 3 and FIG. 4, in an exemplary embodiment, the configuration process 300 is adapted to exchange configuration information utilized for a communication session using the data communication link (task 304). As used herein, a communication session should be understood as communications where content and/or data is transferred or exchanged directly between two computing devices, as opposed to other communication schemes (e.g., a client-server model) that utilize or rely on one or more remote applications or servers to allow interaction between computing devices connected to the server (e.g., software and/or hardware that receive communications and determine the appropriate destination address before routing the content/data). It should be understood that a communication session does not require a direct physical connection for communicating the content and/or data, and the content and/or data may be communicated via one or more intervening devices (e.g., access devices, a local area network, or other network devices and components). Additionally, communication session should be understood as including pure peer-to-peer communications (e.g., devices communicate directly without use of network elements) along with communications utilizing network devices or elements (e.g., computing devices communicate via access devices or other network components or systems).

In accordance with one embodiment, as shown in FIG. 4, both computing devices 402, 404 are connected to the network 400 such that the computing devices 402, 404 are respectively assigned network configuration information (e.g., IP address, subnet mask). The pairing agent may be configured to initiate a data transfer session and facilitate the exchange of configuration information in response to coupling a mobile computing device to a host computing device. In accordance with one embodiment, the configuration information is automatically exchanged (e.g., the data transfer session is automatically initiated) in response to establishing the data communication link. During the data transfer session, the mobile computing device may receive configuration information relating to the host computing device, and the host computing device may receive configuration information relating to the mobile computing device.

For example, if TCP/IP protocol is to be used for the communication session between the respective computing devices the configuration information may include an IP address associated with the respective computing device. If a particular application executing on the respective computing devices will be utilizing the data received via the communication session, the configuration information may also include a port identifier corresponding to the application that will utilize the communication session. A pairing agent executing on the host computing device may provide the IP address associated with the host computing device along with a port identifying a specific application on the host computing device to the pairing agent executing on the mobile computing device. The pairing agent executing on the mobile computing device may provide the IP address associated with the mobile computing device along with a port identifying a specific application on the mobile computing device to the pairing agent on the host computing device. Depending on the embodiment, the computing devices may exchange the configuration information either simultaneously or sequentially.

Referring again to FIG. 3, in an exemplary embodiment, the configuration process 300 is adapted to configure or update the computing devices with the exchanged configuration information to enable a communication session (task 306). In accordance with one embodiment, the pairing agent executing on the mobile computing device may configure the mobile computing device and/or an application executing on the mobile computing device with the configuration information corresponding to the host computing device. Similarly, the pairing agent executing on the host computing device may configure the host computing device and/or an application executing on the host computing device with the configuration information corresponding to the mobile computing device. For example, in the context of the TCP/IP example discussed above, the pairing agent may configure or update the respective computing device and/or the application on the computing device that will utilize the communication session with the received IP address and port identifier, respectively. Alternatively, the pairing agent may provide the configuration information to a specific application executing on the computing device, and the application may be capable of automatically updating or configuring itself without intervention or assistance on behalf of the user and/or pairing agent.

In an exemplary embodiment, the two computing devices may be decoupled after the configuration information is exchanged. In accordance with one embodiment, one of the computing devices (or an application or pairing agent executing thereon) may be configured to signal that the exchange of configuration information is complete, for example, by issuing an audible signal (e.g., a beep) or a visual signal (e.g., a message or notification displayed on the device).

Referring now to FIG. 3 and FIG. 5, in an exemplary embodiment, the configuration process 300 is configured to establish a communication session between the computing devices over a network using the exchanged configuration information (task 308). For example, in one embodiment shown in FIG. 5, the two computing devices 402, 404 communicate in a communication session over the wireless network 400 (e.g., wirelessly). It should be appreciated that although FIG. 5 depicts both computing devices 402, 404 communicating over the network 400 wirelessly, that in other embodiments, either or both computing devices 402, 404 may connect to the network 400 and communicate in a communication session via a physical connection (e.g., Ethernet).

In accordance with one embodiment, the communication session is automatically established in response to decoupling the two computing devices. In alternative embodiments, the communication session may be automatically established after the computing devices are updated with the exchanged configuration information (e.g., task 306), and the computing devices may or may not remain coupled. In another embodiment, the communication session may be established when an application on one of the computing devices indicates a desire or need to utilize the communication session.

In an exemplary embodiment, the configuration process 300 is configured to transmit data between the computing devices using the communication session (task 310). For example, as shown in FIG. 5, the mobile computing device 402 may include a data acquisition module (e.g., a barcode scanner or RFID reader) adapted to read, decode, or otherwise obtain data and/or information from a data tag 502 (e.g., a barcode or RFID tag). A user may use the mobile computing device 402 (e.g., the data acquisition module 224) to obtain data and/or information from the data tag 502 (or alternatively, input data using the user interface 204). In response to reading the data tag 502, an associated application on the mobile computing device 402 may be configured to transmit the obtained data to the host computing device 404 over the network 400 utilizing the communication session. A counterpart application on the host computing device 404 may receive and/or import the data and proceed accordingly with further processing. In this manner, the applications and/or the communication session may be cooperatively configured to allow the mobile computing device 402 to effectively simulate and/or act as if it were a peripheral device connected to the host computing device 404.

It should be appreciated that the subject matter described herein enables a user to quickly associate two computing devices for a communication session over a network, with limited effort or skill on behalf of the user. The user is not required to manually obtain or input configuration information into the respective computing devices and/or applications utilizing the communication session. Further, a computing device may be associated with another computing device with relative ease. For example, if a user wants to associate a mobile computing device with another host computing device (e.g., a different workstation), the user merely has to couple the mobile computing device with the host computing device and wait briefly for the configuration process to update the respective computing devices with configuration information to enable a new communication session. Additional modifications may be made to allow for more than one computing device to communicate with the same computing device (e.g., multiple mobile computing devices communicating with the same workstation).

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for configuring a first computing device and a second computing device for operation over a wireless network, the method comprising:
coupling the first computing device and the second computing device to establish a data communication link; and
exchanging configuration information using the data communication link, the configuration information being utilized for communication over the wireless network between the first computing device and the second computing device.

2. The method of claim 1, further comprising decoupling the first computing device and the second computing device after exchanging the configuration information.

3. The method of claim 1, further comprising establishing a communication session over the wireless network between the first computing device and the second computing device using the configuration information.

4. The method of claim 3, wherein the communication session is automatically established in response to decoupling the first computing device and the second computing device.

5. The method of claim 3, further comprising transmitting data from the first computing device to the second computing device using the communication session.

6. The method of claim 1, wherein exchanging configuration information comprises the second computing device transferring a first IP address and a first port identifier to the first computing device.

7. The method of claim 6, further comprising the first computing device configuring itself with the first IP address and the first port identifier.

8. The method of claim 1, wherein exchanging configuration information comprises the first computing device transferring a second IP address and a second port identifier to the second computing device.

9. The method of claim 1, wherein configuration information is automatically exchanged in response to establishing the data communication link.

10. A method for provisioning a mobile computing device for wireless communication with a host computing device, the method comprising:
coupling the mobile computing device to the host computing device to establish a data communication link;
initiating a data transfer session in response to coupling the mobile computing device to the host computing device;
the mobile computing device receiving first configuration information corresponding to the host computing device from the host computing device during the data transfer session; and
the mobile computing device configuring itself with the first configuration information to enable wireless communication with the host computing device.

11. The method of claim 10, wherein the first configuration information comprises a port identifier and an IP address associated with the host computing device.

12. The method of claim 10, further comprising:
transferring second configuration information corresponding to the mobile computing device to the host computing device during the data transfer session; and
the host computing device configuring itself with the second configuration information to enable wireless communication with the mobile computing device.

13. The method of claim 12, wherein the second configuration information comprises a port identifier and an IP address associated with the mobile computing device.

14. The method of claim 12, further comprising establishing a communication session over a wireless network between the mobile computing device and the host computing device.

15. The method of claim 14, wherein the communication session is automatically established in response to decoupling the mobile computing device and the host computing device.

16. The method of claim 14, further comprising transmitting data from the mobile computing device to the host computing device using the communication session.

17. A mobile computing device for use in a wireless network, the mobile computing device comprising:
a wireless transceiver;
a physical data communication interface;
a processing architecture coupled to the physical data communication interface and the wireless transceiver; wherein the processing architecture and the physical data communication interface are cooperatively configured to:
establish a data communication link with a host computing device using the physical data communication interface;
exchange configuration information using the data communication link; the configuration information being utilized for establishing a communication session over the wireless network between the mobile computing device and the host computing device; and
automatically configure the mobile computing device with the configuration information to enable the communication session with the host computing device using the wireless transceiver.

18. The mobile computing device of claim 17, wherein the processing architecture and the wireless transceiver are cooperatively configured to establish the communication session over the wireless network between the mobile computing device and the host computing device using the configuration information.

19. The mobile computing device of claim 18, further comprising a data acquisition module adapted to obtain data from an external source, wherein the processing architecture is configured to transmit the data corresponding to the external source from the data acquisition module to the host computing device using the communication session.

20. The mobile computing device of claim 18, further comprising a user interface adapted to obtain user input, wherein the processing architecture is configured to transmit data corresponding to the user input to the host computing device using the communication session.
